(19) United States
(12) Patent Application Publication
(10) Pub. No.: US 2004/0187257 A1
(43) Pub. Date: Sep. 30, 2004

(54) Elongate and flexible strip structure

(76) Inventor: Yue Kuen Chiou, Taichung City (TW)

Correspondence Address: CHARLES E. BAXLEY, ESQUIRE, 59 John Street, Fifth Floor, New York, NY, 10038, US

(21) Appl. No.: 10/402,685

(22) Filed: Mar. 28, 2003

(51) Int. Cl. E05B 1/00

(52) U.S. Cl. 16/114.1

(57) ABSTRACT

An elongate strip includes a solid portion and two enlarged portions are integrally connected to two ends of the solid portion. Each enlarged portion is integrally connected to a connection portion. The solid portion, the enlarged portions and the connection portions are made, by soft fabric strips. The connection portions are wide and flat and a width of each of the connection portions is wider than a diameter of the solid portion. The elongate strip can be used as a handle of a luggage bag, a leash or a belt.

### FIELD OF THE INVENTION

The present invention relates to an elongate and flexible strip that includes at least one solid portion and at least one flexible portion in different diameter and shapes so as to be used in different situations.

### BACKGROUND OF THE INVENTION

A first conventional handle 11 for luggage is shown in FIG. 1 and generally includes two pieces which are fixed to two sides of the body 1 of luggage and the handle 11 is made by weaving fabric strips so that it is soft and flexible. A mediate portion of the handle 11 is folded into a planar portion 12 and so that the users have a larger area to hold. The planar portion 12 of the handle 11 is thin and flexible so that when the load of the luggage is heavy, the planar portion 12 is deformed and becomes narrower and a large pressure is applied to the user's hand.

FIG. 2 shows a second conventional handle 11 for luggage and includes a rubber made coat 2 mounted to the planar portion 12 to form a holding portion. Although the coat 2 improves the shortcoming of the first conventional handle 11, it requires too many processes to make the coat 2 and the folded planar portion 12. In other words, the assemblers have to mount the coat 2 to the handle 1 first and then to fold up the handle 11 to be the planar portion 12, and then fixing the coat 2 onto the planar portion 12. Too much labor is needed to manufacture the handle 11.

FIG. 3 shows a third conventional handle for luggage and generally includes a rubber made sleeve 101 which has a passage defined therethrough and a solid bar 12 is inserted in the passage. The combination of the sleeve 101 and the bar 12 is then enclosed by the woven handle 10. Because the bar 120 is not fixed in the sleeve 101 so that when pulling the handle at an angle, the sleeve 101 could slip relative to the bar 12 and this makes the whole assembly deform. Besides, each of the three parts 10, 101, and 12 needs an individual machine to made so that the manufacturing cost is high and the assembly still requires a lot of labor effort.

The present invention intends to provide an elongate and flexible strip that has strong structural strength and can be used as handles of luggage bags, or be cooperated with hooks and rings to form an enclosed ring.

### SUMMARY OF THE INVENTION

In accordance with one aspect of the present invention, there is provided an elongate and flexible strip which comprises a solid portion and two connection portions located at two ends of the handle portion. The solid portion and the connection portions both are made by weaving soft fabric strips as a one-piece member. The two connection portions are fixed to the body of luggage.

The present invention will become more obvious from the following description when taken in connection with the accompanying drawings which show, for purposes of illustration only, a preferred embodiment in accordance with the present invention

### BRIEF DESCRIPTION OF THE DRAWINGS

FIG. 1 is a perspective view to show a first conventional handle for luggage;

FIG. 2 is a perspective view to show a second conventional handle for luggage;

FIG. 3 is an exploded view to show a third conventional handle for luggage;

FIG. 4 is a perspective view to show the strip of the present invention;

FIG. 5 shows the strips are sued as handles of a bag;

FIG. 6 shows another embodiment of the strips used as handles to a bag;

FIG. 7 shows yet another embodiment of the strip of the present invention;

FIG. 8 shows an exploded view to show a further embodiment of the strips used as handles and the fixing members for fixing the handles to a bag;

FIG. 9 shows another embodiment of the strip used as a leash of the present invention;

FIG. 10 shows another embodiment of the strip used as a leash of the present invention;

FIG. 11 shows a user leashes a dog with the strip used as the leash, and FIG. 12 shows the strip used as a belt.

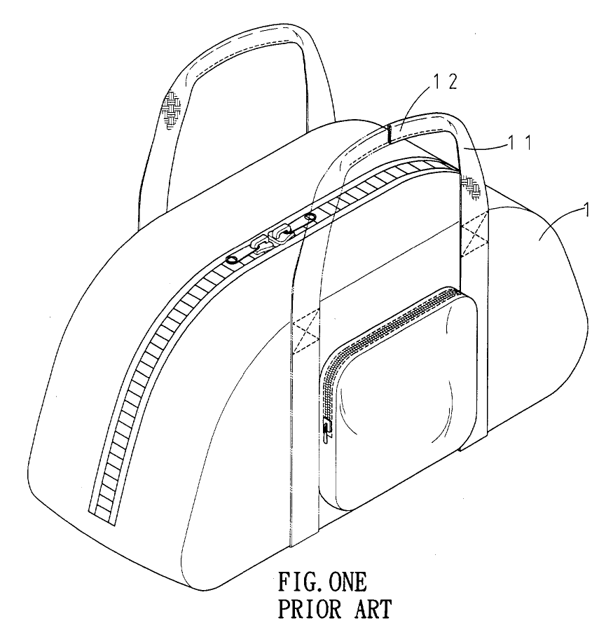

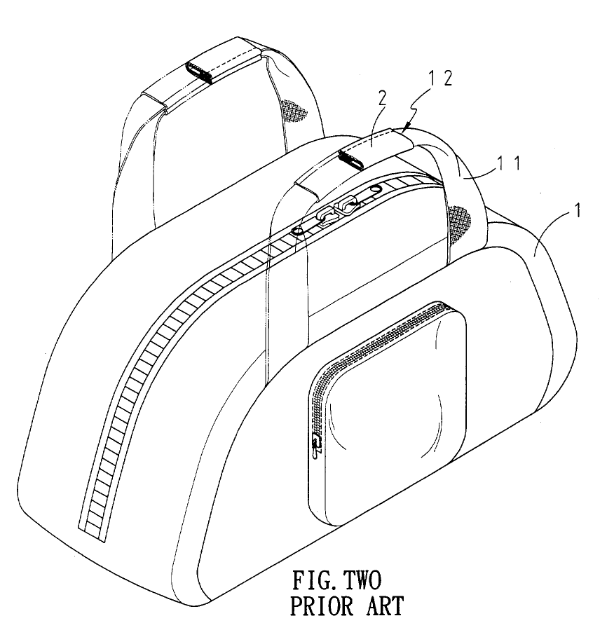

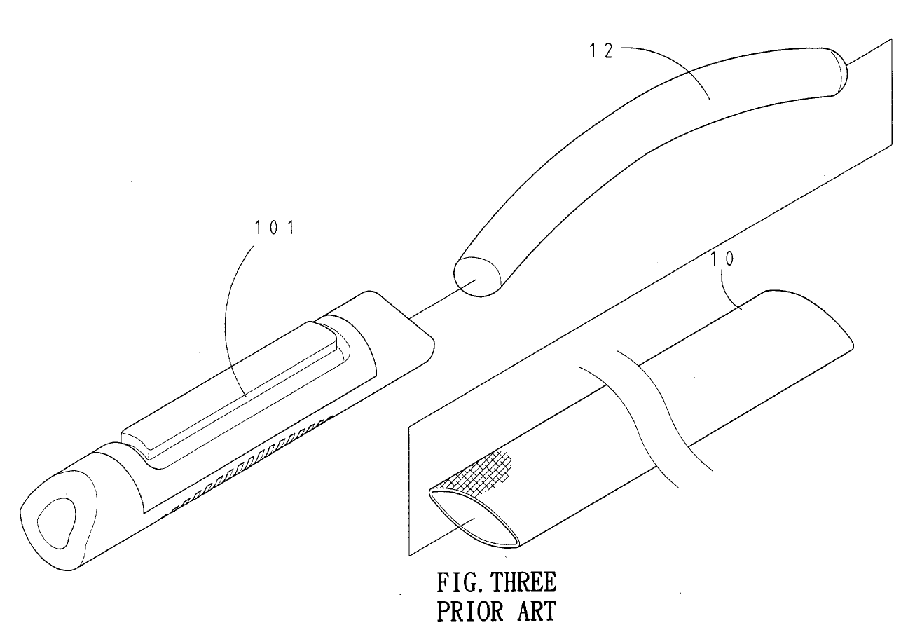

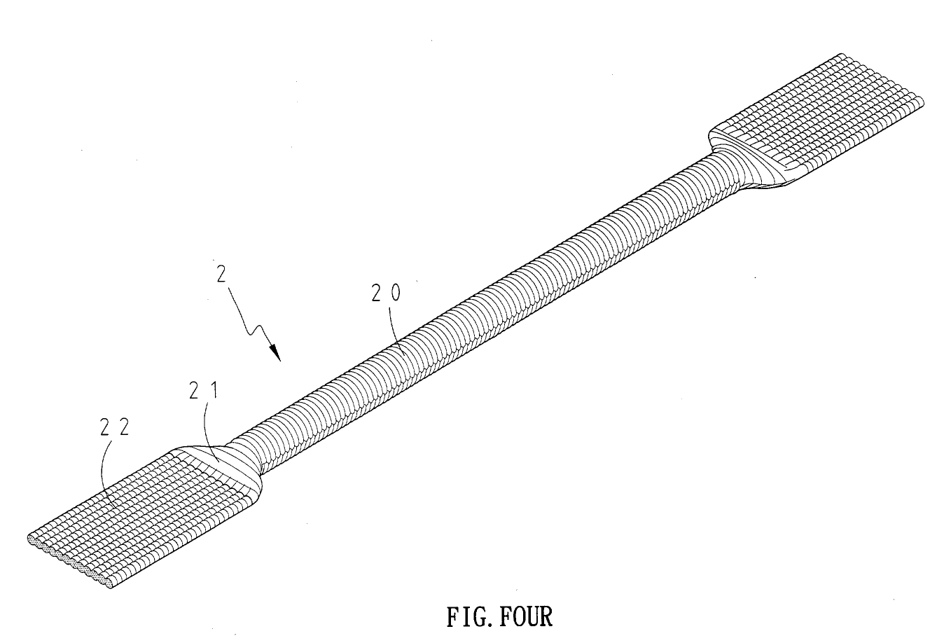

### DETAILED DESCRIPTION OF THE PREFERRED EMBODIMENTS

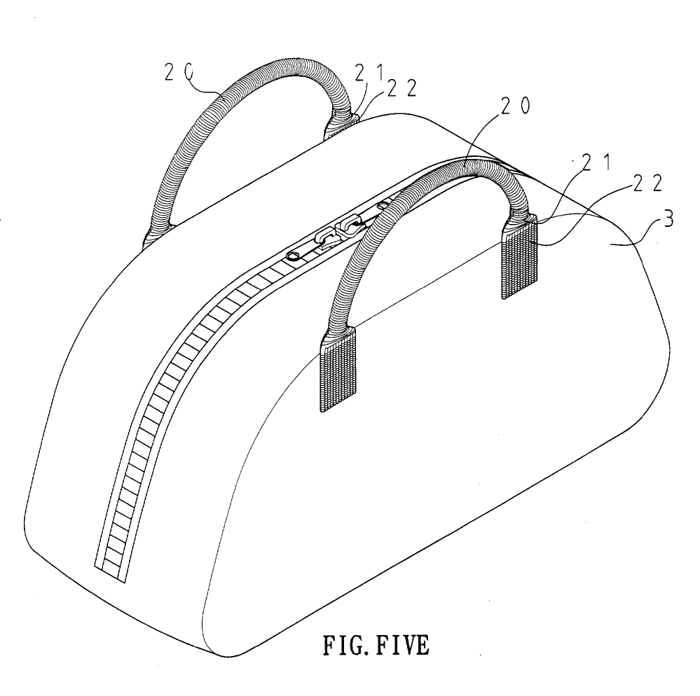

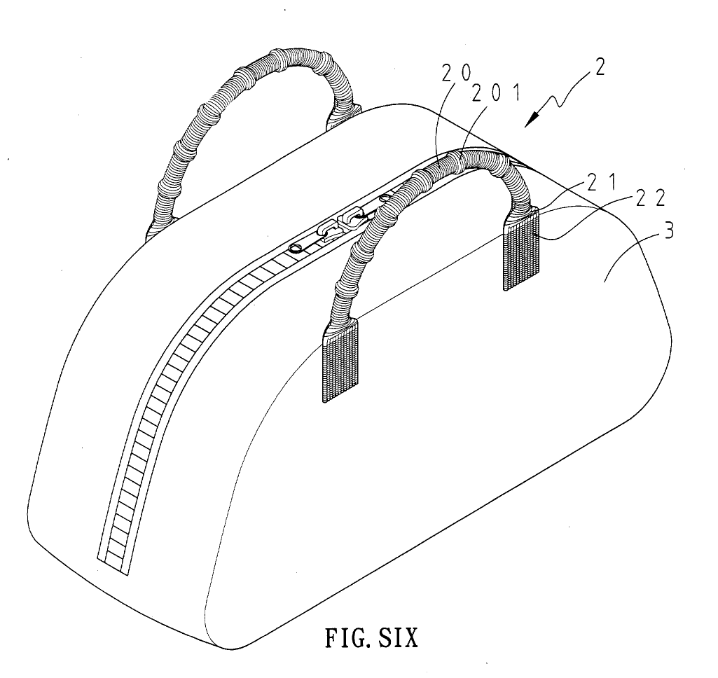

Referring to FIGS. 4 and 5, the elongate and flexible strip 2 used as handles for luggage bag of the present invention comprises a solid portion 20 and two enlarged portions 21 are connected to two ends of the solid portion 20. The enlarged portions 21 each have a larger width than that of the solid portion 20. Each of the enlarged portions 21 has a connection portions 22 extending therefrom. The solid portion 20;, the enlarged portions 21 and the connection portions 22 are made by weaving from soft fabric strips as a one-piece member, and can be made in mass production by machine.

The strip 2 can be used as handles for luggage bags 3 and the connection portions 22 are wide and flat members. A width of each of the connection portions 22 is wider than a diameter of the solid portion 20. The two connection portions 22 are fixed to the bag 3 and the wide and thick enlarged portions 21 provide a strong structural for bearing stress when in practical use.

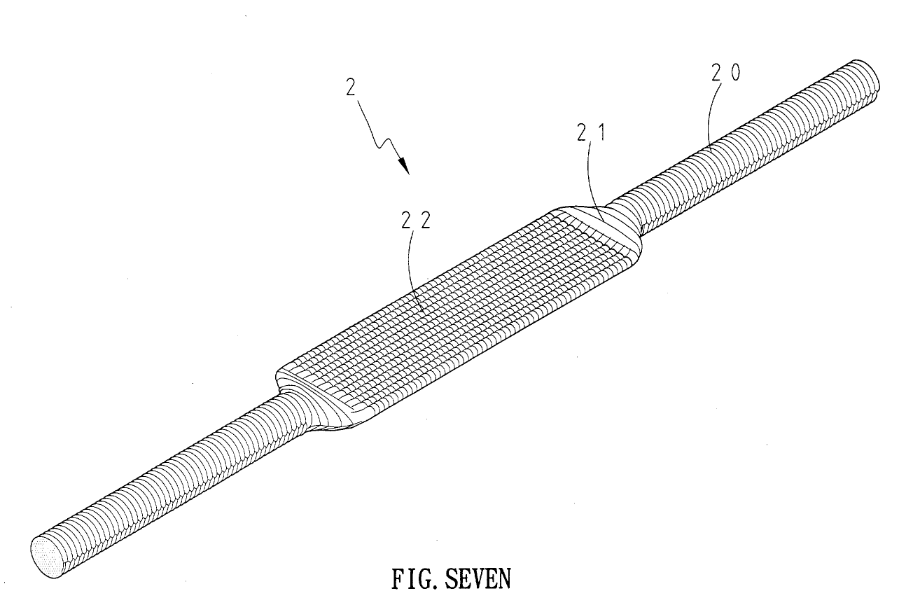

FIG. 6 shows that a plurality of ridges 201 extend radially outward from an outer surface of the solid portion 20 and these ridges 201 provide a comfortable holding feeling for the user's hand.

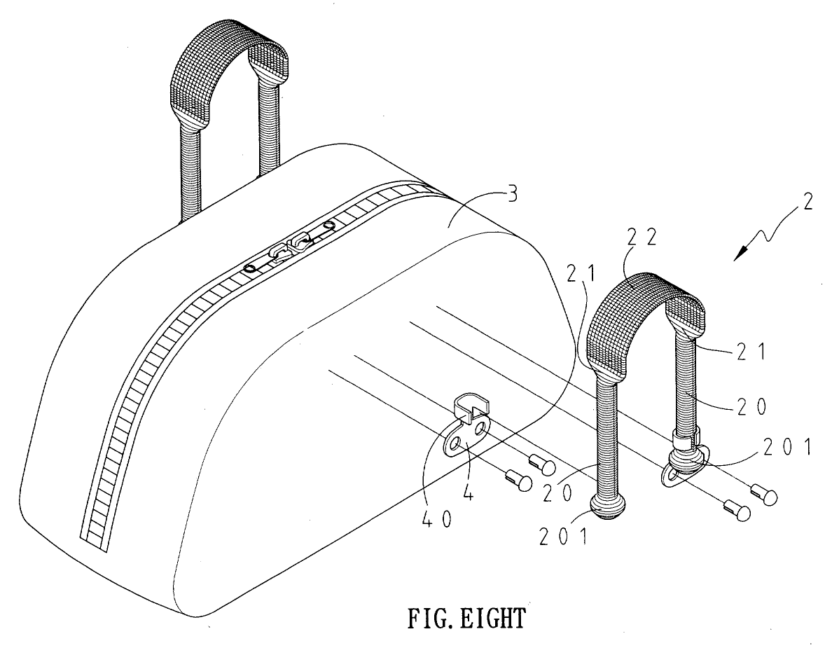

FIG. 7 shows that the strip 2 can be can be made to be that a wide and flat connection portion 22 located between two solid portions 20 with two enlarged portions 21 connected therebetween as shown. This arrangement can be used as a shoulder strip so that the flat connection portion 22 is placed on the shoulder such that less stress concentration is applied on the user's shoulder.

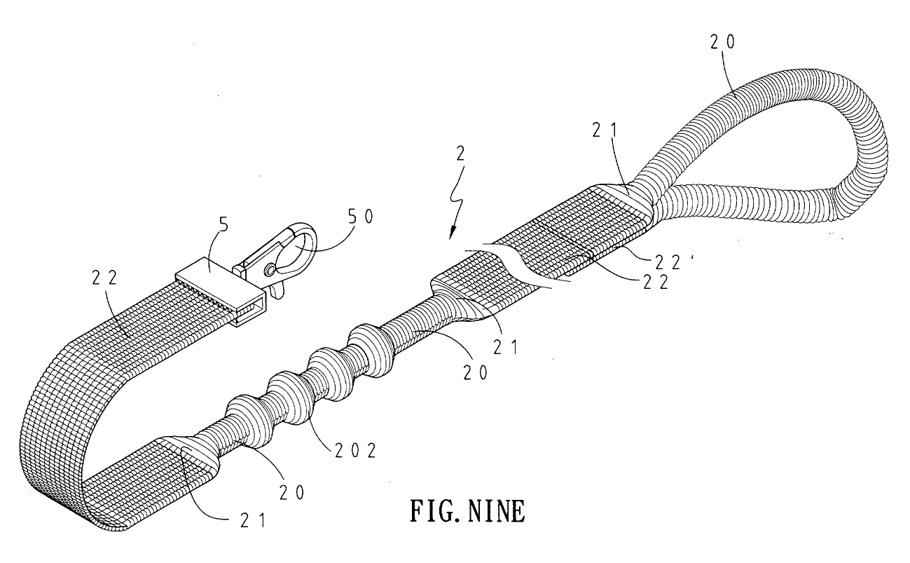

FIG. 8 shows an enlarged end 201 is formed at a distal end of each of the two solid portions 20 and a flat connection portion 22 is connected between the two enlarged portions 21 from which two respective solid portions 20 extend. Two fixing members 4 are fixed to a body 3 of luggage bag by rivets. Each fixing member 4 includes a U-shaped plate 40 extending therefrom so that two arms of the U-shaped. plate 40 are bent to enclose the solid portion 20. A inner diameter of the enclosed arms of the U-shaped plate 40 is smaller than a diameter of the enlarged end 201 so as to limit the enlarged end 201 from disengaging therefrom.

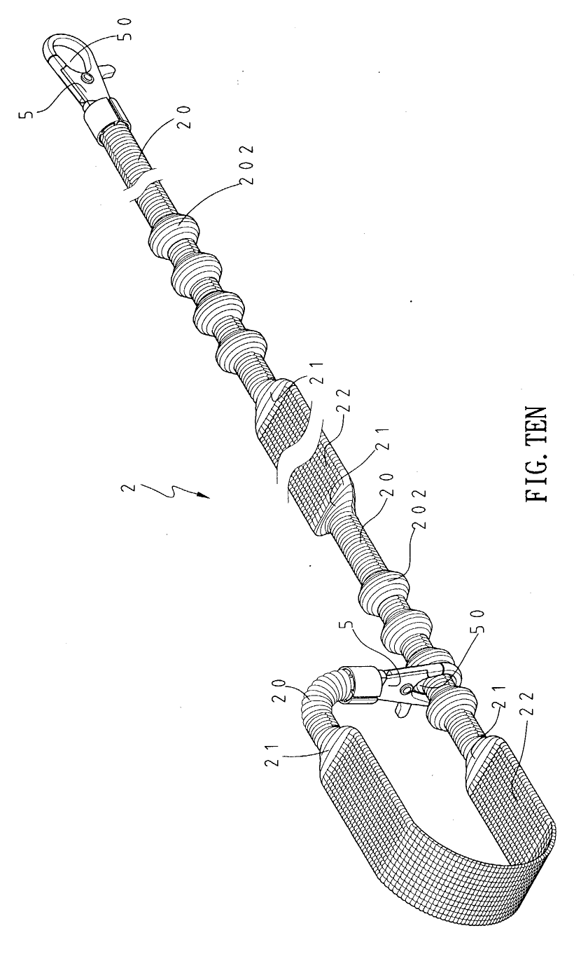

Referring to FIG. 9, the elongate strip 2 may include two solid portions 20 and two connection portion 22 are respectively connected to the two solid portions 20, wherein one of the solid portions 20 has ridges 202. An end plate 5 is connected to an end of one of the two connection portions 22 and a hooking member 50 is connected to the end plate 5. The other connection portion 22 is connected to a loop which is made of a solid portion 20. The loop is formed by fixing a connection portion 22′ connected to solid portion 20 to the connection. portion 22.

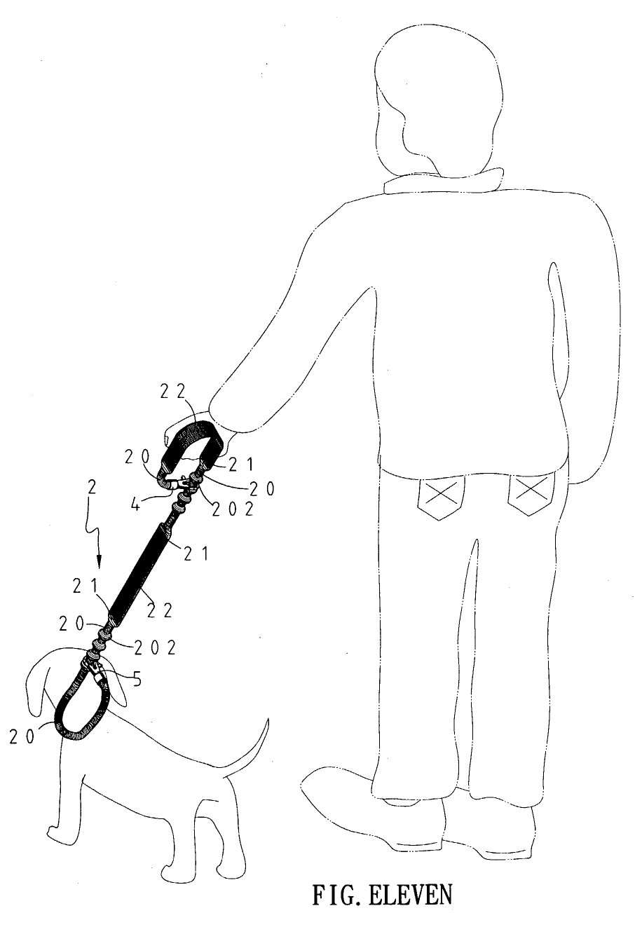

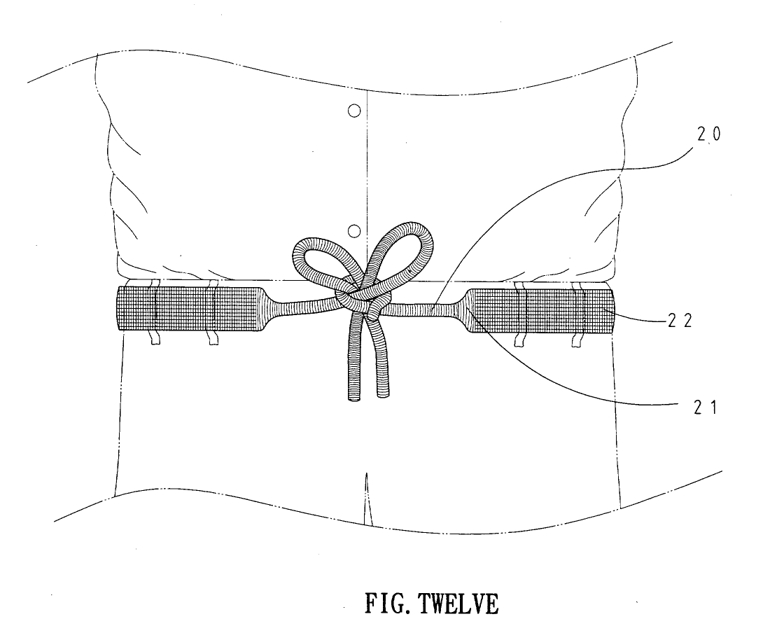

FIG. 10 shows that the elongate strip 2 may include multiple solid portions 20 and connection portions 22, wherein-two sets of end plate 5 and hooking member 50 are respectively connected to the two ends of the elongate strip 2 to be used as a leash as shown in FIG. 11.

FIG. 12 shows that the elongate strip may be used as a belt by making a tie by two solid portions 20 on two ends of the elongate strip 2.

While we have shown and described the embodiment in accordance with the present invention, it should be clear to those skilled in the art that further embodiments may be mad without departing from the scope of the present invention.

What is claimed is:

1. An elongate strip comprising:
a solid portion and two enlarged portions integrally connected to two ends of the solid portion, each enlarged portion being integrally connected to a connection portion, the solid portion, the enlarged portions and the connection portions being made by soft fabric strips, and
the connection portions being wide and flat, a width of each of the connection portions being wider than a diameter of the solid portion.

2. The handle as claimed in claim 1 further comprising a plurality of ridges extending radially outward from an outer surface of the solid portion.

3. The handle as claimed in claim 1 further comprising a hooking member connected to a distal end of each of the two connection portions.

4. The handle as claimed in claim 1 further comprising a loop connected to a distal end of each of the two connection portions.

5. An elongate strip comprising:
a flat connection and two enlarged portions integrally connected to two ends of the connection portion, each enlarged portion being integrally connected to a solid portion, the solid portion, the enlarged portions and the connection portions being made by soft fabric strips, and
the connection portions being wide and flat, a width of each of the connection portions being wider than a diameter of the solid portion.

6. The handle as claimed in claim 5 further comprising a plurality of ridges extending radially outward. from an outer surface of each. of the solid portions.

7. The handle as claimed in claim 5 further comprising a hooking member connected to a distal end of each of the two solid portions.
